(19) United States
(12) Patent Application Publication
(10) Pub. No.: US 2017/0111728 A1
(43) Pub. Date: Apr. 20, 2017

(54) BONE CONDUCTION SPEAKER MODULE AND BONE CONDUCTION EARPHONES HAVING BONE CONDUCTION SPEAKER MODULES

(71) Applicant: DAESUNG M-TECH CO., LTD., Changwon-si, Gyeongsangnam-do (KR)

(72) Inventors: Duk-Kyu KIM, Gyeongsangbuk-do (KR); Seok-Kyu KANG, Incheon (KR); Nam-Sik CHOI, Incheon (KR); Sang-Kyu KANG, Seoul (KR); Sung-Heum BAEK, Incheon (KR); Joo-Hoon SEONG, Daegu (KR); ill-sun KANG, Daegu (KR)

(73) Assignee: DAESUNG M-TECH CO., LTD., Changwon-si, Gyeongsangnam-do (KR)

(21) Appl. No.: 15/315,855

(22) PCT Filed: Jul. 1, 2015
(86) PCT No.: PCT/KR2015/006755

§ 371 Date: Dec. 2, 2016

(30) Foreign Application Priority Data
Jul. 1, 2014 (KR) 10-2014-0082103
Jul. 9, 2014 (KR) 10-2014-0086187

(51) Int. Cl. H04R 1/10; H04R 9/06

(52) U.S. Cl. CPC H04R 1/1075; H04R 9/06; H04R 2460/13

(57) ABSTRACT

Disclosed are a bone conduction speaker module and bone conduction earphones having the bone conduction speaker modules. More particularly, the present invention relates to a bone conduction speaker module and bone conduction earphones having the bone conduction speaker modules, wherein the bone conduction speaker modules can accurately output sound, can stably output sound with fewer vibrations, enable a wearer to comfortably use the earphones, can prevent strain to the wearer by minimizing influence of magnetic force, can facilitate wearing of the earphones, and can prevent an accident from occurring by allowing the wearer to hear external sounds. To this end, a bone conduction speaker module used in earphones, headphones, and a hearing aid, includes: a housing including a first casing covering a portion coming into contact with a human body and a second casing covering a side of the first casing; a magnet part; and a voice coil part.

### TECHNICAL FIELD

The present invention relates generally to a bone conduction speaker module and bone conduction earphones having the bone conduction speaker modules. More particularly, the present invention relates to a bone conduction speaker module and bone conduction earphones having the bone conduction speaker modules, wherein the bone conduction speaker modules can accurately output sound by minimizing distortion of an input signal, can stably output sound with fewer vibrations, enable a wearer to comfortably use the earphones by minimizing vibrations transmitted to the wearer, can prevent strain to a wearer even when used for a long time by minimizing influence of magnetic force of a magnet provided in the module on the wearer, can facilitate wearing thereof by being configured as in-ear type earphones, and can prevent an accident that may occur when the wearer cannot hear external sound by allowing the wearer to naturally hear external sounds.

### BACKGROUND ART

In general, there are two ways in which humans can hear sound: air conduction and bone conduction.

Among these, air conduction denotes a way in which sound waves are transmitted to the inner ear via the eardrum. Sound waves that are normally transmitted by air are transmitted to the eardrum, and vibrations of the eardrum are transmitted to “cochlea” via three bones attached to the other side of the eardrum.

Accordingly, the cochlea is filled with a watery liquid called Perilymph, and vibrations of the liquid are converted into electrical impulses to be sent along the auditory nerve, whereby the human brain can recognize sound.

Alternatively, bone conduction denotes a way in which sound waves are transmitted to the cochlea via the cranial bone, whereafter electrical impulses are transmitted to the brain via the auditory nerve, and a process in which sound waves vibrate the eardrum and the three bones attached to the eardrum is omitted.

In other words, sound waves applied to the skin surface around the ear are transmitted directly to the cochlea via the cranial bone. Thus, a hearing-impaired person who has a problem with the eardrum or the ossicles can clearly hear sound if the cochlea and the auditory nerve are normal.

Meanwhile, air-conduction type earphones and headphones are employed while blocking the ears, such that external sound is prevented from being heard and thus the risk of an accident is increased. Accordingly, in developed countries, listening to music on the road by wearing air-conduction earphones and headphones that block ears is prohibited by law.

Furthermore, due to remarkable spread of digital sound and communication devices in recent years, more than 10% of the population now suffers from hearing loss due to an increased exposure to noise during adolescence. Moreover, due to aging populations in many countries, age-related hearing loss is also socially problematic, and thus reducing volume of a speaker and hours of use has been proposed as an alternative.

Thus, a bone conduction speaker is employed while the ears are not blocked, such that accidents can be prevented by not blocking ambient noise at the same time as using the speaker and hearing loss can be prevented via the bone conduction principle without any direct influence on the eardrum.

Further, a typical bone conduction speaker is configured such that a vibrator is provided outside a speaker housing to improve the output of the speaker. Accordingly, amplitude increases with an increase in the volume, and thus user irritation where the speaker contacts the body and dizziness with a headache may be generated when the bone conduction speaker is used for a long time.

Moreover, the typical bone conduction speaker has a significantly reduced ability to reproduce a stereo sound, and thereby has a fatal limitation of technology due to it only being able to provide a mono sound. Thus, use of the bone conduction speaker for stereo audio has serious quality limitations.

As an example of a speaker using bone conduction in the related art, Korean Patent No. 10-0770590 discloses a technique in which a speaker 300, which is designated by referential numeral 300 in FIGS. 1 to 2, includes: a cylindrical first magnet 301; a cylindrical second magnet 302 spaced apart from the first magnet 301 in an outer direction thereof by a predetermined distance; a cylindrical pole piece 303 spaced apart from the first magnet 301 in an inner direction thereof by a predetermined distance; a lower plate 304 for guiding magnetic flux while supporting the first magnet 301, the second magnet 302 and a rear end of the pole piece 303; a donut-shaped first upper plate 305 provided at an upper end of the first magnet 301; a donut-shaped second upper plate 306 provided on an upper end of the second magnet 302 outside the first upper plate 305; a third upper plate 307 provided at an upper end of the pole piece 303 inside the first upper plate 305; a cylindrical first vibration coil 308 vibrating in a first vibration space 301a formed between the first magnet 301 and the pole piece 303; a cylindrical first bobbin 309 on which the first vibration coil 308 is wound; a cylindrical second vibration coil 310 vibrating in a second vibrating space 302a formed between the first magnet 301 and the second magnet 302; a cylindrical second bobbin 311 on which the second vibration coil 310 is wound; a first vibration material 312 fixed to an upper end of the first bobbin 309 and vibrating the medium (generally, air) while vibrating in accordance with vibrations of the first bobbin 309; a second vibration material 313 fixed to an upper end of the second bobbin 311 and vibrating the medium (which may be the bone or air) while vibrating in accordance with vibrations of the second bobbin 311; a donut-shaped first frame 314 fixed between the first bobbin 309 and the second bobbin 311 and supporting the first vibration material 312 while being fixed to an upper end of the second upper plate 311; a donut-shaped second frame 315 fixed to an upper end of the second upper plate 306 and supporting the second vibration material 313 together with the first frame 314; edges 316 and 317 resiliently supporting the second vibration material 313 on the first and second frames 314 and 315; and a grill 318 covering an upper portion of the first frame 314 and provided with a plurality of openings 318a so that vibrations of the first vibration material 312 can be output to the front surface thereof.

However, the technique disclosed in the Korean Patent No. 10-0770590 has an advantage in that sound is reproduced by bone conduction such that even those who cannot hear the sound by air conduction due to damage to the eardrum can hear sound in a stable manner, whereas there is a contradictory problem in that a magnet provided in the speaker is provided at a position close to the body part of a wearer, and the magnet is configured such that a size and quantity thereof are increased to increase the output of the speaker, and thus strong magnetic force adversely affects the human body. There is a further problem in that sound quality is remarkably deteriorated when sound is reproduced, and costs are increased due to a complex structure of parts of the speaker.

Further, this bone conduction speaker disclosed in the Korean Patent No. 10-0770590 outputs a volume of about 50 to 60% lower than that of the conventional air conduction type headphones. Thus, there is a problem in that reception ratio is significantly reduced in an external noisy environment so it is difficult to receive sound clearly.

Moreover, as described above, the conventional bone conduction speaker has a low output, so when an amplifier is used to increase the output, vibrations due to amplification are increased and accordingly are transmitted to the wearer and to the outside. Thus, the conventional bone conduction speaker is problematic in that it is inconvenient to use, and noise caused by the vibrations is generated in the surroundings.

In addition, the conventional bone conduction speaker is further problematic in that a support having a good elasticity is required to be worn on the head of the wearer, and thus an overall size is increased, it is difficult to store, and it is uncomfortable to wear.

### DISCLOSURE

### Technical Problem

Accordingly, the present invention has been made keeping in mind the above problems occurring in the related art, and the present invention is intended to propose a bone conduction speaker module and bone conduction earphones having the bone conduction speaker modules, in which a voice coil part and a magnet are provided in first and second casings to reproduce sound, and a coil support that supports the voice coil part is formed into a bar shape and only a first end of the coil support is fixed so that the voice coil part freely vibrates, such that attenuation due to the coil support is minimized, and thus an input signal can be accurately realized without distortion, sound can be stably output with minute vibrations, and sound of good quality can be output without provision of a vibration plate.

Further, another object of the present invention is to propose a bone conduction speaker module and bone conduction earphones having the bone conduction speaker modules, in which a coil support at which a voice coil part is installed is fixed at an end portion to an end portion of a first support protrusion part that protrudes from an inner surface of a second casing, and the first support protrusion part is connected to the second casing at only a lower end thereof in such a manner as to transmit vibrations of the voice coil part that are transmitted through the coil support, without as little attenuation as possible, such that sound can be stably output with small vibrations, and the wearer feels only very minute vibrations with a small amplitude even though the wearer comes into direct contact therewith, thereby not being discomforted by the bone conduction earphones during use.

A further object of the present invention is to propose a bone conduction speaker module and bone conduction earphones having the bone conduction speaker modules, in which a configuration provided in first and second casings is minimized, such that occurrence of distortion due to vibrations generated in a voice coil part are minimized by portions where respective components are combined with each other, and thus an input signal can be more accurately output, and noise pollution can be reduced by minimizing leakage of sound to the outside so as not to be heard by people near the wearer.

Further, still another object of the present invention is to propose a bone conduction speaker module and bone conduction earphones having the bone conduction speaker modules, in which a magnet part provided in a lower portion of a voice coil part is installed in a second casing provided at a side of a first casing that comes into close contact with the human body, and the magnet part includes a permanent magnet and a magnet cover provided an outer side of the magnet, such that influence of a magnet force on the wearer is minimized and thus strain on a body part of the wearer in contact with the earphones is prevented when earphones are used for a long time.

Further, yet another object of the present invention is to propose a bone conduction speaker module and bone conduction earphones having the bone conduction speaker modules, in which an insertion part inserted into the external auditory canal is formed at a first side of an earphone body to configure in-ear type earphones such that the earphones can be worn without provision of a pressurizing support, and a through hole is formed through the insertion part to communicate with an upper portion of the earphone body such that external sound can be easily heard, and thus an accident that may occur when external sound cannot be heard can be prevented.

Further, yet another object of the present invention is to propose a bone conduction speaker module and bone conduction earphones having the bone conduction speaker modules, in which a module part that generates sound is provided at a side portion of a through hole passing through both an earphone body and an insertion part, and the through hole and the module part communicate with each other by a communication part, such that an air-conducted sound partially generated by bone conduction vibrations generated in the module part is transmitted to the eardrum by air conduction, and a filter is provided in the communication part such that foreign substances entering into the through hole from the outside are prevented from being introduced to the module part, and thus sound can be reproduced without loss of quality from the original audio source by transmitting the sound by both bone conduction and air conduction.

### Technical Solution

In order to achieve the above object, according to one aspect of the present invention, there is provided a bone conduction speaker module used in earphones, headphones, and a hearing aid, the module including: a housing including a first casing that covers a portion coming into contact with a human body and a second casing that covers a side of the first casing; a magnet part provided in the housing; and a voice coil part placed at an upper portion of the magnet part.

Here, the voice coil part may be installed at a lower portion of a bar-shaped elastic support, wherein only a first end of the elastic support may be fixedly installed in the housing.

Further, a first support protrusion part may protrude from an inner side of the second casing, and the first end of the elastic support may be fixedly installed at an end of the first support protrusion part.

Meanwhile, the magnet part may include a permanent magnet, and a magnet cover provided at an outer side of the magnet.

Here, the magnet cover may include a seating part on which the magnet is seated, the seating part being configured to be opened in a direction of the second casing.

Here, a second support protrusion part may be provided on an inner side of the second casing, and a magnet support may be provided at an upper end of the second support protrusion part.

Further, a fixing protrusion to which the magnet part is fixed may be provided on the magnet support.

Meanwhile, first and second engagement parts may be provided at portions where the first and second casings come into contact with each other, wherein a groove may be provided on an inner circumferential surface of the first engagement part, and a protrusion may be provided on an outer circumferential surface of the second engagement part so as to correspond to the groove.

Further, the first casing may be further provided with a silicone sheet at the portion coming into contact with the human body.

Meanwhile, according to another aspect of the present invention, there is provided a bone conduction earphone having a bone conduction speaker module, the earphone including: a module part configured with a bone conduction speaker module; an earphone body having the module part therein at a first side thereof; and an insertion part placed at a lower portion of a second side of the earphone body.

Here, a through hole may be formed vertically through both the insertion part and the earphone body so that the insertion part and the earphone body communicate with each other.

Here, a communication part that communicates with the module part may be provided at a side portion of the through hole.

Further, the communication part may be provided with a filter.

### Advantageous Effects

According to the present invention having the above-described characteristics, a voice coil part and a magnet are provided in first and second casings to reproduce sound, and a coil support that supports the voice coil part is formed into a bar shape and only a first end of the coil support is fixed so that the voice coil part can freely vibrate. Thus, attenuation due to the coil support is minimized and thus an input signal can be accurately realized without distortion, whereby sound can be stably output with minute vibrations and good quality sound can be output without provision of a vibration plate.

Further, in the present invention, a coil support at which a voice coil part is installed is fixed at an end portion thereof to an end portion of a first support protrusion that protrudes from an inner surface of a second casing, and the first support protrusion is connected to the second casing at a lower end thereof in such a manner as to transmit vibrations of the voice coil part that are transmitted through the coil support, without as little attenuation as possible. Thus, it is possible that sound can be stably output with small vibrations, and the wearer feels only very minute vibrations with a small amplitude even though the wearer comes into direct contact with the earphones, thereby not being discomforted by the bone conduction earphones during use.

Further, in the present invention, a configuration provided in first and second casings is minimized. Thus, it is possible that occurrence of distortion due to vibrations generated in a voice coil part are minimized by portions where respective components are combined with each other, and thus an input signal can be more accurately output, and noise pollution can be reduced by minimizing leakage of sound to the outside so as not to be heard by people near the wearer.

Further, in the present invention, a magnet part provided in a lower portion of a voice coil part is installed in a second casing provided at a side of a first casing that comes into contact with the human body, and the magnet part includes a permanent magnet and a magnet cover provided outside of the magnet, such that influence of a magnet force on the wearer is minimized. Thus, it is possible to prevent strain to body part of the wearer in contact with the earphones even when the earphones are used for a long time.

Further, in the present invention, an insertion part inserted into the external auditory canal is formed at a first side of an earphone body to configure in-ear type earphones, so it is possible to wear the earphones without provision of a pressurizing support, and a through hole is formed through the insertion part to communicate with an upper portion of the earphone body, so that external sound can be easily heard. Thus, it is possible to prevent an accident from occurring when external sound cannot be heard.

Further, in the present invention, a module part that generates sound is provided at a side portion of a through hole passing through both an earphone body and an insertion part, and the through hole and the module part communicate with each other by a communication part, such that an air conduction sound partially generated by bone conduction vibrations generated in the module part is transmitted to the eardrum by air conduction, and a filter is provided in the communication part such that foreign substances entering into the through hole from the outside are prevented from being introduced to the module part. Thus, it is possible to reproduce sound without loss of quality from the original audio source by transmitting sound by both bone conduction and air conduction.

### DESCRIPTION OF DRAWINGS

FIG. 1 is an exploded perspective view showing a bone conduction headphone in the related art.

FIG. 2 is a cross-sectional view showing the bone conduction headphone in the related art.

FIG. 3 is a perspective view showing a bone conduction speaker module according to the present invention.

FIG. 4 is an exploded perspective view showing the bone conduction speaker module according to the present invention.

FIG. 5 is a cross-sectional view showing the bone conduction speaker module according to the present invention.

FIG. 6 is a graph showing an output of a typical bone conduction speaker as a function of frequency.

FIG. 7 is a graph showing an output of the bone conduction speaker module according to the present invention as a function of frequency.

FIG. 8 is a cross-sectional view showing a state in which a magnet protrudes from a magnet seating part since the magnet seating part of a magnet cover has a shallow depth.

FIG. 9 is a perspective view showing a bone conduction earphone having the bone conduction speaker module according to the present invention.

FIG. 10 is a cross-sectional view showing the bone conduction earphone having the bone conduction speaker module according to the present invention.

FIG. 11 is a cross-sectional view showing a bone conduction earphone having the bone conduction speaker module, the earphone provided with a plug that seals a through hole according to another embodiment of the present invention.

FIG. 12 a cross-sectional view showing a bone conduction earphone having a bone conduction speaker module according to a further embodiment of the present invention.

### BEST MODE

Reference will now be made in greater detail to an exemplary embodiment of the present invention, an example of which is illustrated in the accompanying drawings. Wherever possible, the same reference numerals will be used throughout the drawings and the description to refer to the same or like parts, and the duplicated descriptions of the same or like parts will be omitted. In addition, it should be understood that the present invention may be implemented in a variety of embodiments, and the scope and spirit of the present invention is not limited to the exemplary embodiments described hereinbelow.

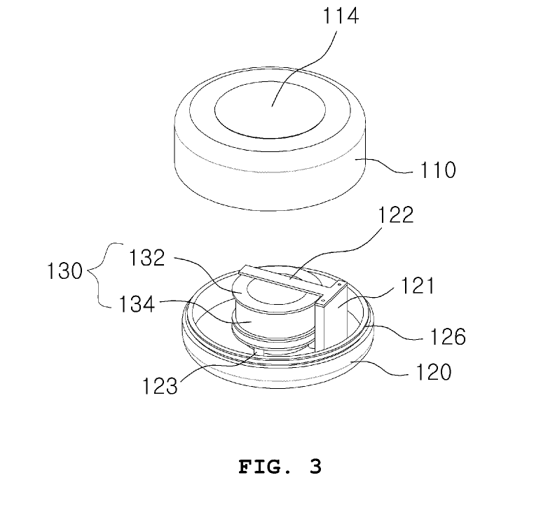

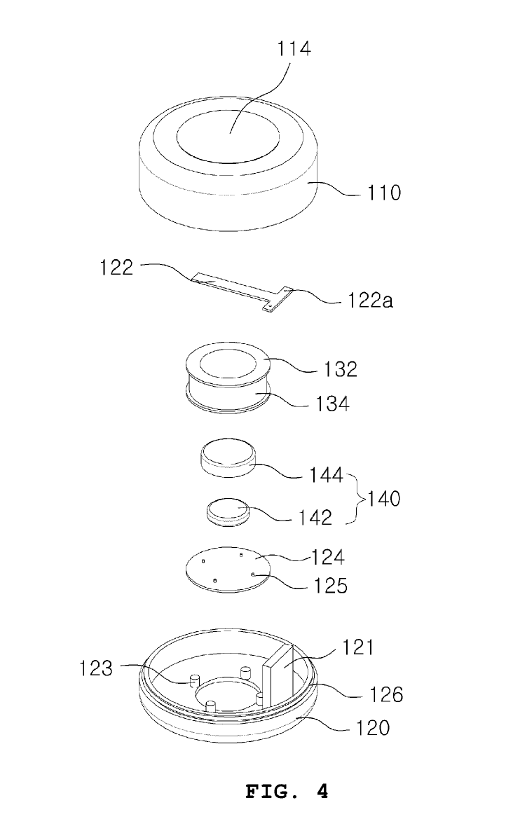

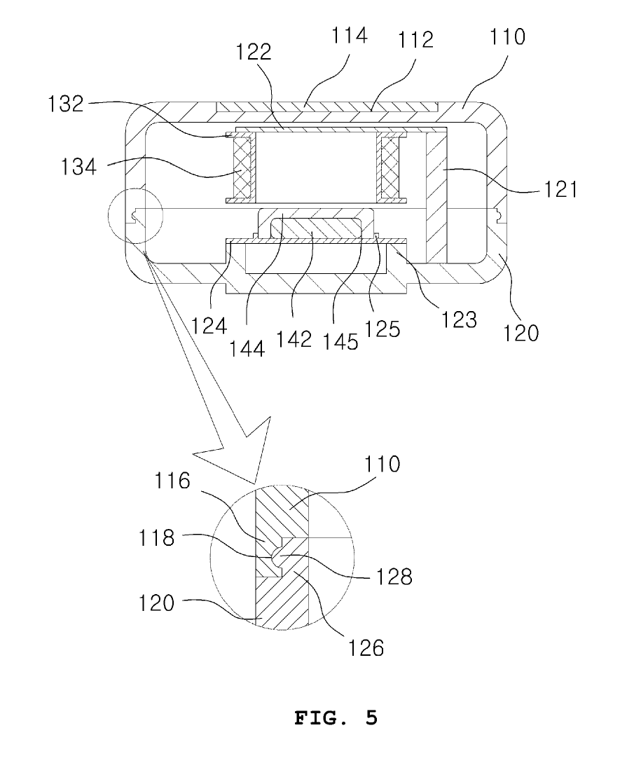

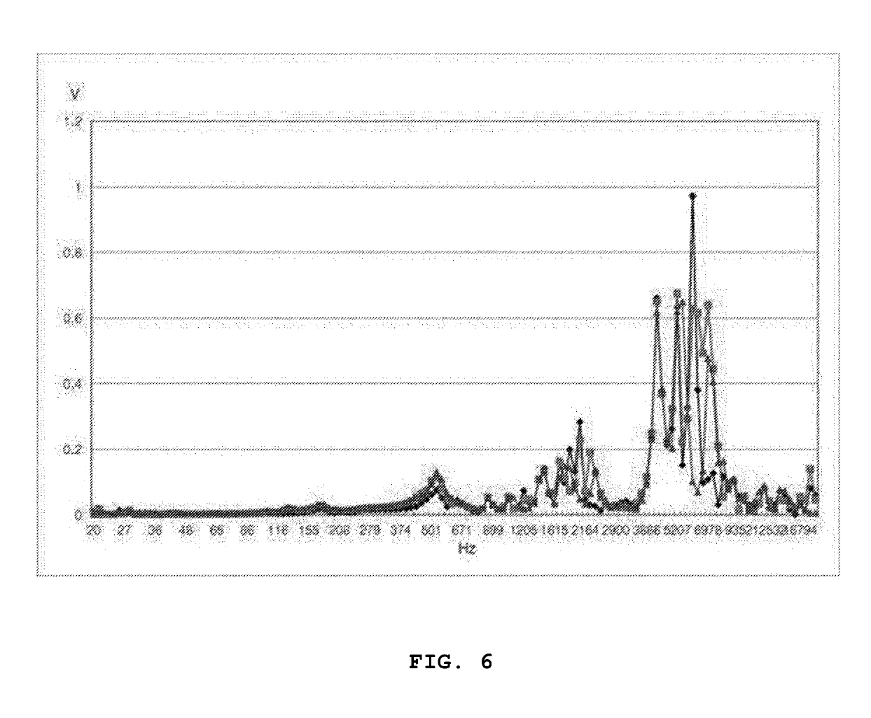

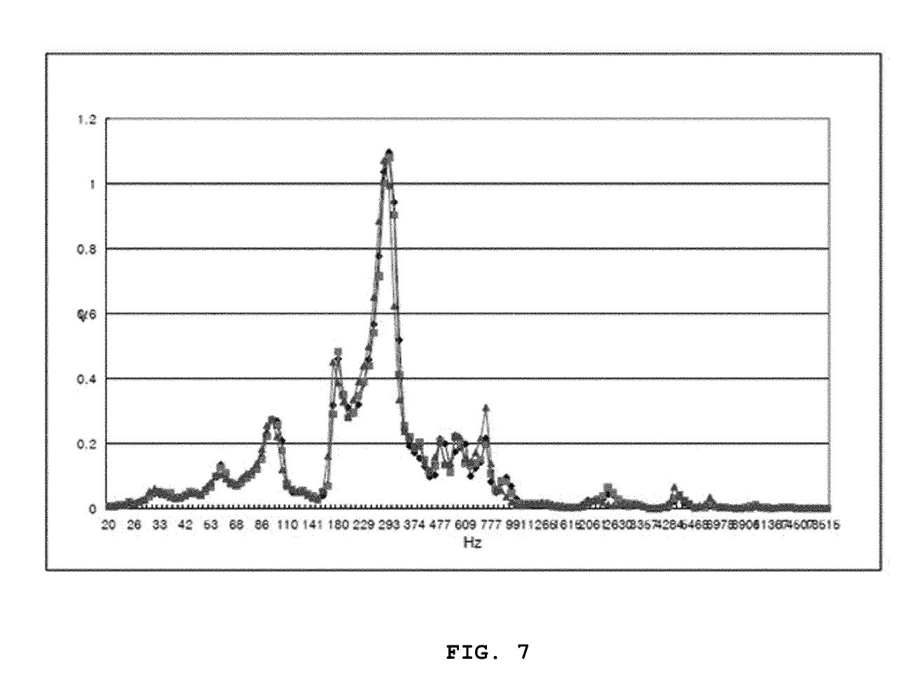

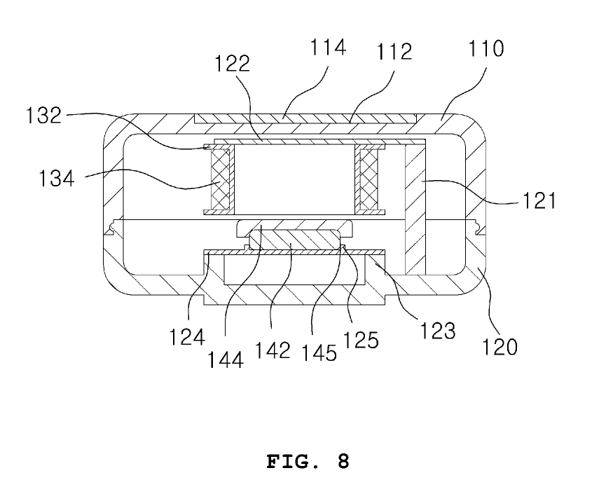

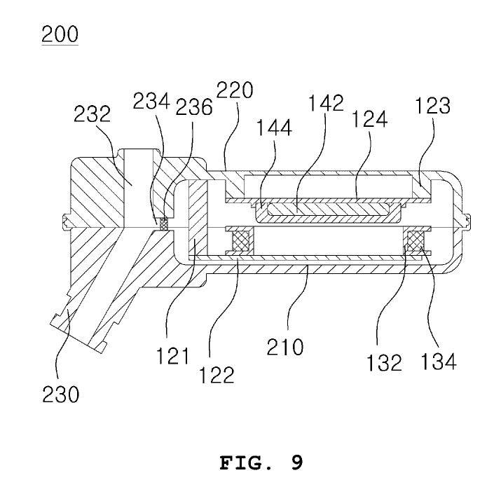

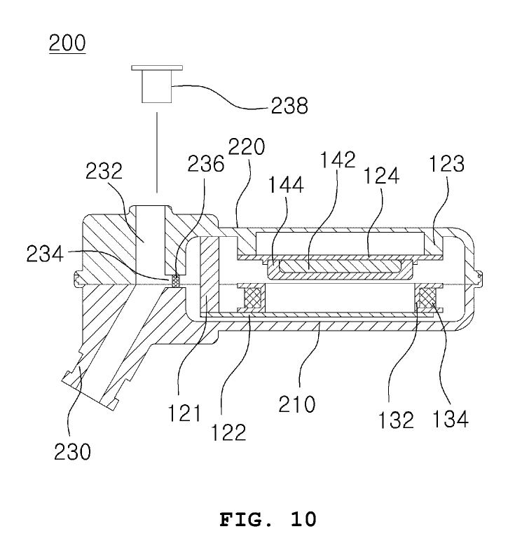

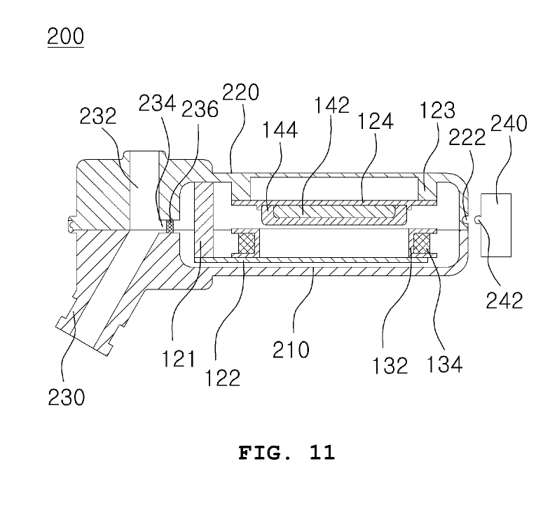

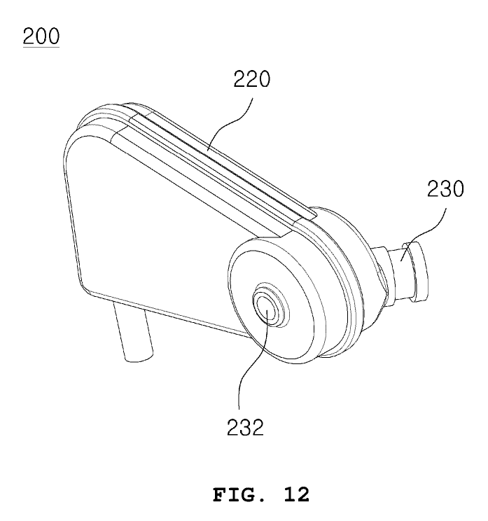

FIG. 3 is a perspective view showing a bone conduction speaker module according to the present invention, FIG. 4 is an exploded perspective view showing the bone conduction speaker module according to the present invention, FIG. 5 is a cross-sectional view showing the bone conduction speaker module according to the present invention, FIG. 6 is a graph showing an output of a typical bone conduction speaker as a function of frequency, FIG. 7 is a graph showing an output of a bone conduction speaker module according to the present invention as a function of frequency, FIG. 8 is a cross-sectional view showing a state in which a magnet protrudes from a magnet seating part since the magnet seating part of a magnet cover has a shallow depth, FIG. 9 is a perspective view showing a bone conduction earphone having the bone conduction speaker module according to the present invention, FIG. 10 is a cross-sectional view showing the bone conduction earphone having the bone conduction speaker module according to the present invention, FIG. 11 is a cross-sectional view showing a bone conduction earphone having the bone conduction speaker module, the earphone provided with a plug that seals a through hole according to another embodiment of the present invention, and FIG. 12 a cross-sectional view showing a bone conduction earphone having a bone conduction speaker module according to a further embodiment of the present invention.

The present invention relates to a bone conduction speaker module provided in earphones, headphones, a hearing aid, etc. so as to reproduce sound, and bone conduction earphones having bone conduction speaker modules. First, with reference to FIGS. 3 to 5, the bone conduction speaker module includes a housing 100, a voice coil part 130 provided in the housing 100, and a magnet part 140.

Here, the housing 100 includes a first casing 110 that covers a portion coming into contact with a human body and a second casing 120 that covers a side of the first casing 110. The first and second casings 110 and 120 may be configured in a variety of shapes depending on application such as the earphones, the headphones, and the hearing aid.

Further, the first and second casings 110 and 120 are detachably coupled with each other. First and second engagement parts 116 and 126 are respectively provided at portions where the first and second casings 110 and 120 come into contact with each other. A groove 118 is provided on an inner circumferential surface of the first engagement part 116 of the first casing 110, and a protrusion 128 is provided on an outer circumferential surface of the second engagement part 126 of the second casing 120 so as to correspond to the groove 118.

Accordingly, the protrusion 128 of the second engagement part 120 is fixedly inserted into the groove 118 of the first engagement part 116. Thus, the first and second casings 110 and 120 are stably engaged with each other in such a manner as to be prevented from being arbitrarily separated from each other.

Meanwhile, the voice coil part 130 provided in the housing 100 includes a bobbin 132 and a voice coil 134 wound on an outer circumferential surface of the bobbin 132. Here, the voice coil part 130 is installed at a lower portion of an elastic support 122 having elastic force, and the elastic support 122 is formed into a bar shape and only a first end thereof is fixedly installed in the housing 100.

Here, a first support protrusion part 121 protrudes from an inner side of the second casing 120 that covers the side of the first casing 110, such that the first end of the elastic support 122 that elastically supports the voice coil part 130 is fixedly installed at an upper end of the first support protrusion part 121.

Here, the elastic support 122 is configured with a third engagement part 122a provided at the first end to which the first support protrusion part 121 is coupled, such that the elastic support 122 is fixedly adhered to or is stably fixed by a screw or a nail to the upper end of the first support protrusion part 121. Thus, vibrations generated in the voice coil part 130 are transmitted to the housing 100 through the elastic support 122 and the first support protrusion part 121, and the vibrations thus transmitted are transmitted to a body part of a wearer that comes into contact with the housing 100.

Further, the elastic support 122 is formed into the bar shape, and only the first end thereof is fixed so that the elastic support 122 can freely vibrate. Thus, when the voice coil part 130 provided at the lower portion of the elastic support 122 is vibrated by a signal applied thereto, power that attenuates vibration force is minimized such that the signal can be accurately reproduced. Moreover, the attenuation of the applied signal is minimized, and thus sound can be stably output even if output of the signal is low.

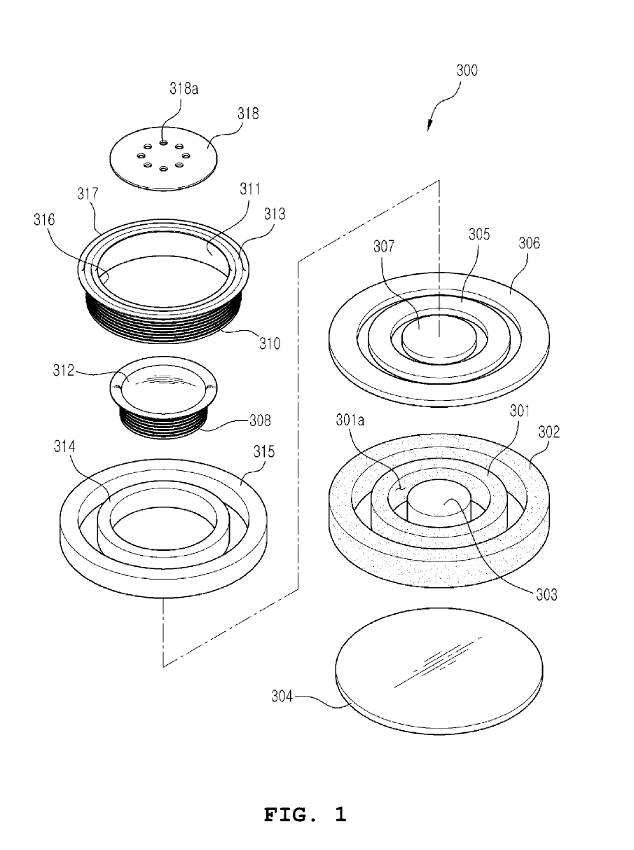

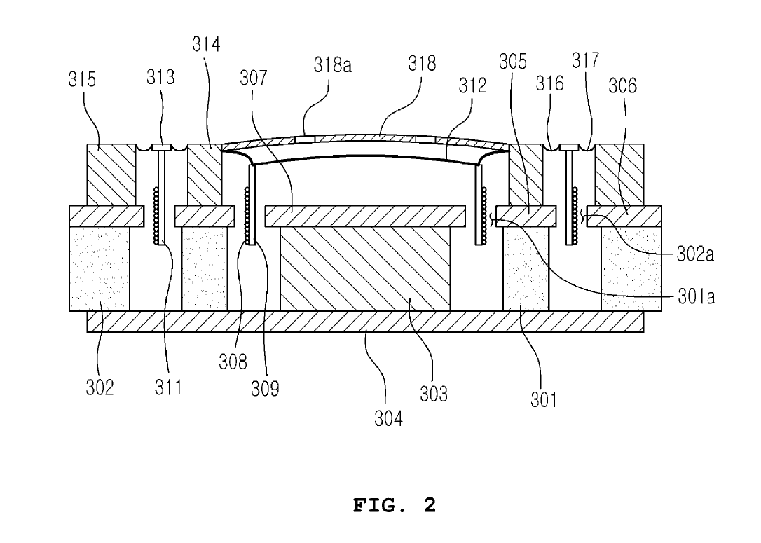

In other words, with reference to FIGS. 1 to 2, in the related art, a vibration material 312 provided at an upper end of a bobbin 309 is formed into a disc shape so that an entire outer circumferential surface thereof is fixed. Accordingly, when the bobbin 309 on which a voice coil is wound vibrates, vibration force is attenuated more than a certain level such that it is difficult to accurately reproduce a signal, and output of the signal is lowered due to attenuation of the signal. On the other hand, in the present invention, the elastic support 122 at which the voice coil part 130 installed is formed into the bar shape, and only the first end thereof is fixed such that the elastic support 122 freely vibrates, and thus the attenuation of the signal is minimized. Thus, the signal can be accurately output and increased.

Accordingly, in the related art, when output of the signal is reduced, it can be increased by using an amplifier, etc. In this case, the output becomes higher while the amplitude becomes larger. When the wearer brings the bone conduction speaker into contact with a body part, vibrations of the bone conduction speaker are directly transmitted to the wearer, and thus it is difficult for the wearer to use. On the other hand, in the present invention, the elastic support 122 minimizes a degree of attenuation, so there is no need to use the amplifier, and accordingly amplitude is not increased, so when sound is reproduced, vibrations of the bone conduction speaker are minimized. Thus, the wearer feels minute vibrations even though the bone conduction speaker is in contact with the wearer, thereby the user can comfortably use the bone conduction speaker for long periods of time.

Further, since amplitude in the voice coil part 130 is low, it is possible to stably prevent leakage of sound to the outside. Thus, people near the wearer can be prevented from hearing the sound so as to avoid inconvenience due to noise.

Further, the first casing 110 is further provided with a silicone sheet 114 at a portion where the body part of the wearer comes into contact with the earphone. Here, a sheet seating groove 112 is provided on the first casing 110 so that the silicone sheet 114 is installed thereon.

Thus, the silicone sheet 114 comes into contact with the body part of the wearer, thereby ensuring high wearing comfort, and preventing strain to the wearer even when the bone conduction speaker is used for long periods of time.

In other words, in the related art, since a bone conduction speaker comes into contact with a body part of the wearer to transmit sound, the speaker part is forced by an additional cradle (not shown) in a direction of the body part of the wearer. Thus, when the bone conduction speaker is continuously forced toward the wearer, strain is put on the body part of the wearer. On the other hand, in the present invention, the silicone sheet 114 is provided at the portion where body part of the wearer comes into contact with the speaker, thereby the portion that comes into contact with body part of the wearer is soft. Thus, the speaker can be used without discomfort even for long periods of time.

Meanwhile, the magnet part 140 includes a permanent magnet 142 and a magnet cover 144 provided on an outer side of the magnet 142. The magnet part 140 is installed at the second casing 120 provided at the side of the first casing 110 that comes into close contact with the body part of the wearer. Thus, influence of magnetic force emitted from the magnet 142 on the wearer can be minimized.

Further, the magnet cover 144 has a magnet seating part 145 on which the magnet 142 is seated. Here, the magnet seating part 145 is opened at a first side thereof in a direction of the second casing 120 where the body part of the wearer is not in contact with, such that the magnet cover 144 reduces magnetic force emitted relative to the wearer in such a manner that an adverse effect on the wearer's health is minimized. Thus, earphones, headphones, etc., mounted with the bone conduction speaker module of the present invention can be used stably for long periods of time.

Here, the magnet cover 144 is made of brass or aluminum or Steel Use Stainless (SUS) so as to weaken the magnetic force emitted from the magnet 142, thereby minimizing the adverse effect on the wearer due to magnetic force.

Meanwhile, with reference to FIG. 8, depth of the magnet seating part 145 of the magnet cover 144 may be configured to be smaller than thickness of the magnet 142 such that the magnet 142 may protrude outward from the magnet seating part 145.

Further, second support protrusions 124 are provided on the inner side of the second casing 120 at regular intervals, and a magnet support part 124 is provided at an upper end of the second support protrusions 123. Here, the second support protrusion 123 may be installed in a variety of numbers depending on a size and a shape of the second casing 120 in such a manner as to stably support the magnet support part 124.

Here, the magnet support part 124 is formed into a plate shape and has fixing protrusions 125 provided on an upper surface thereof at regular intervals in such a manner as to solidly fix the magnet part 140.

Accordingly, the voice coil part 130 is vibrated by magnetic force generated by signal applied to the voice coil part 130, and the magnetic force generated in the magnet part 140, whereby sound is produced.

Further, the magnet support part 124 may be made of a synthetic resin using injection molding, etc., and may be made of a metal having good elasticity. When the magnet support part 124 is made of the metal having good elasticity, the magnet support part 124 also vibrates in response to the magnetic force generated in the voice coil part 130. Thus, signal can be more accurately reproduced, and the magnet part 130 is solidly and easily installed on the magnet support part 124 made of the metal by attraction force of the magnet 142.

Meanwhile, a vibration space is formed between the magnet part 140 and the voice coil part 130 so that the voice coil part can freely vibrate. Here, a size of the vibration space may be adjusted in accordance with a size of the magnet 142, impedance of the voice coil part 130, elasticity of the elastic support 122, etc. so that volume and sound quality can be optimized to reproduce sound.

Further, an auxiliary space is formed at a lower portion of the magnet support part 124 by the second support protrusion 123 such that vibrations generated by the voice coil part 130 vibrate also in the auxiliary space. Thus, output of the speaker can be improved.

In other words, as compared with the resolution of low frequency sound of a conventional bone conduction speaker shown in FIG. 6, the present invention can reproduce low frequency sound to be almost identical to the original sound and can increase the output of sound, as shown in FIG. 7.

With reference to FIGS. 9 and 10, a bone conduction earphone 200 provided with the bone conduction speaker module having the above-described configuration includes: a module part 210 having the bone conduction speaker module; an earphone body 220 having the module part 210 therein at a first side thereof; and an insertion part 230 placed at a lower portion of the earphone body 220.

Here, the insertion part 230 is placed at the lower portion of a second side of the earphone body 220 in an inclined manner relative to a first side thereof, and thus the earphone 200 can be easily inserted into the external auditory canal of the ear of the wearer.

Further, a sealing member (not shown) made of silicone, etc. is further provided on an outer surface of the insertion part 230 such that even if the size of the external auditory canal is different for each person, the earphone 200 can be stably maintained in a fixed state through the sealing member. Thus, the earphone 200 can be stably worn on the external auditory canal of the ear of the wearer without provision of a pressurizing support of conventional bone conduction headphones.

Here, the bone conduction earphone 200 of the present invention may be configured as two casings (numerals are not shown) like the first and second casings 110 and 120 to have the module part 210 therein, or may be configured in a variety of ways to have the module part 210 therein.

Meanwhile, the insertion part 230 includes a through hole 232 formed vertically through both the earphone body 220 and the insertion part 230 so that the earphone body 220 and the insertion part 230 can communicate with each other.

Accordingly, when the bone conduction earphone 200 of the present invention is worn, external sound is transmitted to be heard through the through hole 232 by air conduction. Thus, an accident that may occur when the wearer with in-ear type earphones cannot hear external sound can be prevented.

In other words, in the related art, when the in-ear type earphones are worn, external sound is completely blocked such that even if a vehicle approaches a wearer from behind or an approaching vehicle sounds a horn, it is often the case that an accident occurs. On the other hand, in the present invention, the through hole 232 is formed through the earphone body 220 and the insertion part 230 so as to communicate with the outside. Thus, external sound can be heard, and thus such an accident can be prevented.

Of course, with reference to FIG. 11, the through hole 232 that passes through both the insertion part 230 and the earphone body 220 may be provided with a plug 238 so as to be hermetically sealed. In this case, it can be used when the wearer wants to concentrate on sound that is output from the earphones by blocking ambient noise in a safe place.

Meanwhile, the earphone body 220 includes the module part 210 at the first side therein, and the through hole 232 at the second side therein, in which a communication part 234 that communicates with the module part 210 is formed at a side portion the through hole 232.

Accordingly, sound that is generated from the module part 210 is transmitted by air conduction as well as bone conduction through the communication part 234 and the through hole 232. Thus, the wearer can hear clearer sound without loss of quality from the original sound source.

Moreover, the communication part 234 is provided with a filter 236 that prevents external foreign substances entering through the through hole 232 from being introduced into the module part 210. Thus, it is possible to prevent noise generation caused by the foreign substances such that sound can be stably output.

Meanwhile, in a further embodiment of the present invention shown in FIG. 12, the earphone body 220 is further provided with an auxiliary sealing member 240 on a side portion thereof in a detachable manner, such that a fixing groove 222 is provided on a side surface of the earphone body 220, and a fixing protrusion 242 is provided on the auxiliary sealing member 240 so as to correspond to the fixing groove 222.

Accordingly, in the case that the wearer's external ear is large, when the bone conduction earphone 200 of the present invention is worn, the earphone 200 is shaken due to an extra space in the external ear. Here, the auxiliary sealing member 240 is engaged with the earphone body 220, thereby widening the space and preventing the earphone 200 from shaking.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bone conduction speaker module used in earphones, headphones, and a hearing aid, the module comprising:
a housing including a first casing that covers a portion coming into contact with a human body and a second casing that covers a side of the first casing;
a magnet part provided in the housing; and
a voice coil part placed at an upper portion of the magnet part.

2. The module of claim 1, wherein the voice coil part is installed at a lower portion of a bar-shaped elastic support, wherein only a first end of the elastic support is fixedly installed in the housing.

3. The module of claim 2, wherein a first support protrusion part protrudes from an inner side of the second casing, and the first end of the elastic support is fixedly installed at an end of the first support protrusion part.

4. The module of claim 1, wherein the magnet part includes a permanent magnet, and a magnet cover provided at an outer side of the magnet.

5. The module of claim 4, wherein the magnet cover includes a seating part on which the magnet is seated, the seating part being configured to be opened in a direction of the second casing.

6. The module of claim 4, wherein a second support protrusion part is provided on an inner side of the second casing, and a magnet support is provided at an upper end of the second support protrusion part.

7. The module of claim 6, wherein a fixing protrusion to which the magnet part fixed is provided on the magnet support.

8. The module of claim 1, wherein first and second engagement parts are provided at portions where the first and second casings come into contact with each other, wherein a groove is provided on an inner circumferential surface of the first engagement part, and a protrusion is provided on an outer circumferential surface of the second engagement part so as to correspond to the groove.

9. The module of claim 1, wherein the first casing is further provided with a silicone sheet at the portion coming into contact with the human body.

10. A bone conduction earphone having a bone conduction speaker module, the earphone comprising:
a module part configured with a bone conduction speaker module;
an earphone body having the module part therein at a first side thereof; and
an insertion part placed at a lower portion of a second side of the earphone body.

11. The earphone of claim 10, wherein a through hole is formed vertically through both the insertion part and the earphone body so that the insertion part and the earphone body communicate with each other.

12. The earphone of claim 11, wherein a communication part that communicates with the module part is provided at a side portion of the through hole.

13. The earphone of claim 12, wherein the communication part is provided with a filter.
